(19) United States
(12) Patent Application Publication
(10) Pub. No.: US 2020/0376375 A1
(43) Pub. Date: Dec. 3, 2020

(54) METHOD AND APPARATUS FOR PERFORMING CLIENT SIDE LATENCY ENHANCEMENT WITH AID OF CLOUD GAME SERVER SIDE IMAGE ORIENTATION CONTROL

(71) Applicant: MEDIATEK INC., Hsin-Chu (TW)

(72) Inventor: Chiung-Fu Chen, Hsinchu City (TW)

(21) Appl. No.: 16/882,764

(22) Filed: May 26, 2020

Related U.S. Application Data
(60) Provisional application No. 62/854,379, filed on May 30, 2019.

(51) Int. Cl. A63F 13/358; A63F 13/211; A63F 13/213

(52) U.S. Cl. CPC A63F 13/358; A63F 13/211; A63F 2300/535; A63F 2300/204; A63F 2300/534; A63F 13/213

(57) ABSTRACT

A method and apparatus for performing client side latency enhancement with aid of cloud game server side image orientation control. The method may include: utilizing at least one orientation-related sensor in a client device to detect a client device orientation of the client device; utilizing a network interface circuit in the client device to notify a cloud game server of the client device orientation; utilizing the cloud game server to rotate video contents of a cloud game in advance for the client device according to the client device orientation to generate pre-rotated video contents, for being output to the client device through video streaming; and utilizing the network interface circuit to receive the pre-rotated video contents through the video streaming and buffering the pre-rotated video contents in a video buffer, for being output to a display panel and displayed on the display panel.

### CROSS REFERENCE TO RELATED APPLICATIONS

This application claims the benefit of U.S. Provisional Application No. 62/854,379, which was filed on May 30, 2019, and is included herein by reference.

### BACKGROUND

The present invention is related to image display, and more particularly, to a method and apparatus for performing client side latency enhancement with aid of cloud game server side image orientation control, where the apparatus may comprise at least one portion (e.g. a portion or all) of an electronic device, such as a host processor, a processing circuit, etc. within the electronic device.

Modern games typically need huge graphics processing unit (GPU) computing power of a GPU to achieve beautiful and complete scenario rendering. More particularly, the heavy load of the GPU may be introduced due to certain types of rendering tasks on the GPU. When a game is designed to be a cloud game, a cloud game server may prepare video contents of the cloud game and transmit the video contents to a client device (e.g. a multifunctional mobile phone) through video streaming, for being played back by the client device. Some problems may occur, however. For example, regarding game play of a landscape mode, the client device may need to rotate buffered video data to match the display orientation, and therefore may increase more latency and bandwidth (BW) consumption. Thus, there is a need of a novel method and associated architecture to enhance the overall performance of an electronic device running the cloud game.

### SUMMARY

An objective of the present invention is to provide a method for performing client side latency enhancement with aid of cloud game server side image orientation control, and to provide associated apparatus such as an electronic device or a host processor, a processing circuit, etc. within the electronic device, as well as a cloud game server, in order to solve the aforementioned problems.

Another objective of the present invention is to provide a method for performing client side latency enhancement with aid of cloud game server side image orientation control, and to provide associated apparatus such as an electronic device or a host processor, a processing circuit, etc. within the electronic device, as well as a cloud game server, in order to enhance overall performance of the electronic device.

At least one embodiment of the present invention provides a method for performing client side latency enhancement with aid of cloud game server side image orientation control. The method may comprise: utilizing at least one orientation-related sensor in a client device to detect a client device orientation of the client device; utilizing a network interface circuit in the client device to notify a cloud game server of the client device orientation; utilizing the cloud game server to generate pre-rotated video contents of a cloud game in advance for the client device according to the client device orientation, for being output to the client device through video streaming, wherein the pre-rotated video contents correspond to the client device orientation; and utilizing the network interface circuit to receive the pre-rotated video contents through the video streaming and buffering the pre-rotated video contents in a video buffer, for being output to a display panel and displayed on the display panel.

At least one embodiment of the present invention provides a host processor within a client device, where the host processor is applicable to performing client side latency enhancement with aid of cloud game server side image orientation control. The host processor may comprise a core circuit, and may comprise a display interface circuit and a bus interface circuit that are coupled to the core circuit. The core circuit may be arranged to control the host processor, for controlling operations of the electronic device, wherein the electronic device is used as a client device, and under control of the core circuit, the host processor performs interaction control of the client device to perform client side latency enhancement with aid of cloud game server side image orientation control. In addition, the display interface circuit may be arranged to couple a display panel to the host processor, and the bus interface circuit may be arranged to couple at least one component to the host processor through a bus, wherein said at least one component comprises at least one orientation-related sensor in the client device. For example, the host processor utilizes said at least one orientation-related sensor to detect a client device orientation of the client device; the host processor utilizes a network interface circuit in the client device to notify a cloud game server of the client device orientation; the host processor utilizes the cloud game server to generate pre-rotated video contents of a cloud game in advance for the client device according to the client device orientation, for being output to the client device through video streaming, wherein the pre-rotated video contents correspond to the client device orientation; and the host processor utilizes the network interface circuit to receive the pre-rotated video contents through the video streaming and buffers the pre-rotated video contents in a video buffer, for being output to the display panel and displayed on the display panel.

According to some embodiments, the present invention further provides a processing circuit comprising the host processor mentioned above, where the processing circuit may further comprise said at least one orientation-related sensor and the network interface circuit. For example, the processing circuit may comprise the video buffer, and the video buffer may be arranged to buffer frame information, wherein the frame information comprises the pre-rotated video contents. In addition, the video buffer may be implemented to be an internal buffer or an external buffer of the host processor.

According to some embodiments, the present invention further provides the electronic device comprising the host processor mentioned above, where the electronic device may comprise a processing circuit and the display panel, and the processing circuit may comprise the host processor, said at least one orientation-related sensor, and the network interface circuit. The display panel may be coupled to the host processor, and may be arranged to display information. For example, the processing circuit may comprise the video buffer, and the video buffer may be arranged to buffer frame information, wherein the frame information comprises the pre-rotated video contents. In addition, the video buffer may be implemented to be an internal buffer or an external buffer of the host processor.

At least one embodiment of the present invention provides a cloud game server, where the cloud game server is applicable to performing client side latency enhancement with aid of cloud game server side image orientation control. The cloud game server may comprise at least one processor (e.g. one or more processors) and a network interface circuit that is coupled to the aforementioned at least one processor. The aforementioned at least one processor may be arranged to control operations of the cloud game server, wherein under control of the aforementioned at least one processor, the cloud game server performs game control and selectively performs image rotation for a client device to perform client side latency enhancement with aid of cloud game server side image orientation control. In addition, the network interface circuit may be arranged to couple the cloud game server to the client device through at least one network. For example, at least one orientation-related sensor in the client device is configured to detect a client device orientation of the client device; the client device is configured to notify a cloud game server of the client device orientation; the cloud game server is configured to generate pre-rotated video contents of a cloud game in advance for the client device according to the client device orientation, for being output to the client device through video streaming, wherein the pre-rotated video contents correspond to the client device orientation; and the client device is configured to receive the pre-rotated video contents through the video streaming and buffer the pre-rotated video contents in a video buffer, for being output to a display panel and displayed on the display panel.

The present invention method and the associated apparatus (e.g. the host processor, the processing circuit, etc. within the electronic device) can properly control operations of the electronic device, and more particularly, can request the cloud game server to perform image rotation on the video contents of the cloud game in advance for the client device and offload image rotation tasks from the client device to the cloud game server, to enhance overall performance of the electronic device. For example, for the game play in a landscape mode, the client device does not need to rotate buffered video data to match the display orientation, and therefore can reduce latency and bandwidth (BW) consumption. In addition, implementing the embodiments of the present invention will not greatly increase additional costs, while solving problems of the related art. In comparison with conventional architecture, the present invention can achieve an optimal performance of the electronic device without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to a first embodiment of the present invention, where a cloud game server is also illustrated for better comprehension.

FIG. 2 is a working flow of a method for performing client side latency enhancement with aid of cloud game server side image orientation control according to an embodiment of the present invention.

FIG. 3 illustrates a control scheme of the method shown in FIG. 2 according to an embodiment of the present invention.

FIG. 4 illustrates some implementation details of the control scheme shown in FIG. 3 according to an embodiment of the present invention, where a 90-degree orientation may be taken as an example of the landscape orientations.

FIG. 5 illustrates some implementation details of the control scheme shown in FIG. 3 according to another embodiment of the present invention, where a 270-degree orientation may be taken as another example of the landscape orientations.

FIG. 6 illustrates some implementation details of the control scheme shown in FIG. 3 according to another embodiment of the present invention, where a 0-degree orientation may be taken as an example of the portrait orientations.

FIG. 7 illustrates some implementation details of the control scheme shown in FIG. 3 according to another embodiment of the present invention, where a 180-degree orientation may be taken as another example of the portrait orientations.

FIG. 8 is a diagram of an electronic device according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

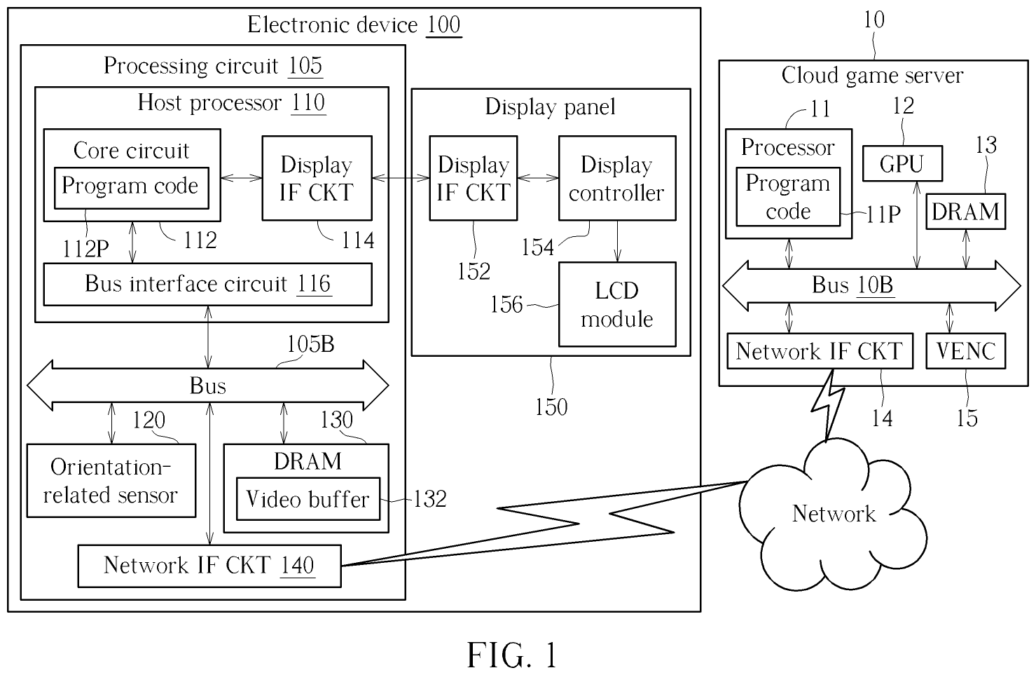

FIG. 1 is a diagram of an electronic device 100 according to a first embodiment of the present invention, where a cloud game server 10 is also illustrated for better comprehension. Examples of the electronic device 100 may include, but are not limited to, a multifunctional mobile phone, a tablet computer, a wearable device, an all-in-one computer, and a laptop computer. The electronic device 100 may be used as a client device of a server (e.g. the cloud game server 10) to provide one or more services for a user, and more particularly, may be used as a game client device of the cloud game server 10 to allow the user to play one or more cloud games. As shown in the upper right of FIG. 1, the cloud game server 10 may comprise a bus 10B and at least one processor (e.g. one or more processors) which may be collectively referred to as the processor 11, and may comprise a graphics processing unit (GPU) 12, a random access memory (RAM) such as a dynamic RAM (DRAM) 13, a network interface circuit 14 (labeled “Network IF CKT” in FIG. 1 for brevity), and a video encoder 15 (labeled “VENC” in FIG. 1 for brevity), where the processor 11, the GPU 12, the DRAM 13, the network interface circuit 140, and the video encoder 15 may be coupled to each other through the bus 10B. For example, at least one storage device (not shown in FIG. 1) of the cloud game server 10 may be arranged to store some program codes 11P. Examples of the program codes 11P may include, but are not limited to, an operating system (OS), one or more drivers, and one or more applications. The processor 11 may load the program codes 11P from the storage device, and run the program codes 11P to control operations of the cloud game server 10. Under the control of the processor 11 running the program codes 11P, the cloud game server 10 may perform game control, and more particularly, may perform image orientation control for the client device such as the electronic device 100 to perform client side latency enhancement (or latency reduction) with aid of cloud game server side image orientation control.

As shown in FIG. 1, the electronic device 100 may comprise a processing circuit 105 and a display panel 150 that is coupled to the processing circuit 105, and the processing circuit 105 may comprise a bus 105B, a host processor 110 (e.g. a central processing unit (CPU)), and at least one orientation-related sensor (e.g. one or more orientation-related sensors) which may be collectively referred to as the orientation-related sensor 120, and may comprise a RAM such as a DRAM 130 and a network interface circuit 140 (labeled “Network IF CKT” in FIG. 1 for brevity), and more particularly, the host processor 110 may comprise a core circuit 112, a display interface circuit 114 (labeled “Display IF CKT” in FIG. 1 for brevity), and a bus interface circuit 116, and the display panel 150 may comprise a display interface circuit 152 (labeled “Network IF CKT” in FIG. 1 for brevity), a display controller 154, and a display module such as a liquid crystal display (LCD) module 156, where the host processor 110, the orientation-related sensor 120, the DRAM 130, and the network interface circuit 140 may be coupled to each other through the bus 105B, and the display interface circuit 114 and the bus interface circuit 116 may be coupled to the core circuit 112 in a manner as shown in FIG. 1, but the present invention is not limited thereto. According to some embodiments, the architecture of the electronic device 100 shown in FIG. 1 may vary. For example, the display module such as the LCD module 156 and a touch-sensitive module (not shown) may be integrated into the same module to form a touch-sensitive display device (e.g. a touch screen), and the touch-sensitive display device may comprise a touch controller for performing touch control to detect user inputs via the touch-sensitive module. In addition, the network interface circuit 14 of the cloud game server 10 and the network interface circuit 140 of the electronic device 100 may be arranged to couple the cloud game server 10 and the electronic device 100 to each other through at least one network. For example, the network interface circuit 140 may comprise multiple wireless communications circuits (e.g. Wi-Fi circuit, mobile network circuit, etc.) conforming to some communications specifications, for performing wireless communications for the electronic device 100.

The processing circuit 105 (e.g. the host processor 110) and the display panel 150 may be coupled to each other through the display interface circuits 114 and 152, and the display interface circuits 114 and 152 may be implemented with interface circuits complying with a specific specification. For example, the specific specification may be the Mobile Industry Processor Interface (MIPI) Display Serial Interface (DSI) specification of the MIPI Alliance, and the display interface circuits 114 and 152 may be implemented to be DSI circuits. As a result, the host processor 110 (e.g. the core circuit 112 therein) may communicate with the display panel 150, for performing associated control for the electronic device 100. In addition, the electronic device 100 may further comprise additional circuits such as a power management circuit, a storage interface circuit, etc. (not shown) to provide the electronic device 100 with capabilities of performing associated operations such as power management, storage interfacing, etc. Additionally, the host processor 110 (e.g. the core circuit 112 therein) may control various operations of the electronic device 100. For example, some program codes 112P running on the host processor 110 (e.g. the core circuit 112) may control the electronic device 100, to make the electronic device 100 be equipped with various functions. Examples of the program codes 112P may include, but are not limited to, an OS, one or more drivers, and one or more applications.

According to this embodiment, the host processor 110 may be arranged to perform interaction control regarding the cloud game. More particularly, the core circuit 112 may be arranged to control the host processor 110, for controlling the operations of the electronic device 100. Under the control of the core circuit 112, the host processor 110 may perform display control of the electronic device 100. For example, the host processor 110 (e.g. the core circuit 112) may set a refresh rate of the display interface circuit 114 to be a target refresh rate in advance, for controlling the host processor 110 to output images to the display panel 150 according to the target refresh rate by default, and may dynamically perform refresh-rate adjustment when there is a need, where the display interface circuit 114 may be arranged to control the timing of outputting image data of the images from a frame buffer (e.g. a video buffer 132 in the DRAM 130) to the display panel 150, but the present invention is not limited thereto. In addition, the display interface circuits 114 and 152 may be arranged to couple the display panel 150 to the host processor 110, and transmit one or more commands and the image data from the host processor 110 to the display panel 150. As a result, the display panel 150 may display information (e.g. the image data) for the electronic device 100.

The one or more applications of the program codes 112P may comprise a client application (APP) of the cloud game. The host processor 110 (e.g. the core circuit 112) may run the client APP of the cloud game to perform the interaction control regarding the cloud game. For example, the cloud game server 10 may transmit at least one video stream of the cloud game to the client device such as the electronic device 100. Under control of the host processor 110 (e.g. the core circuit 112) running the client APP, the electronic device 100 may receive and play the video stream of the cloud game for the user, where the video stream may carry the image data (e.g. image frames) and the associated audio data of the cloud game. The host processor 110 (e.g. the core circuit 112) running the client APP may utilize the touch-sensitive module or the touch screen of the electronic device 100 to detect user control such as user touch behavior (e.g. click, drag, etc. that the user applied to the touch-sensitive module or the touch screen with his/her fingers), and utilize the network interface circuit 140 to transmit user control information of the user control to the cloud game server 10 through the network. As a result, the cloud game server 10 may change the image data (e.g. image frames) and the associated audio data of the cloud game in response to the user control. In addition, the host processor 110 (e.g. the core circuit 112) running the client APP may utilize the orientation-related sensor 120 to perform orientation-related sensing for the electronic device 100 to generate multiple orientation detection results at multiple time points, respectively, and utilize the network interface circuit 140 to transmit the respective orientation detection results of the multiple time points to the cloud game server 10 as real-time feedback regarding game client orientation, where the multiple orientation detection results may indicate client device orientations of the client device (e.g. the electronic device 100) at these time points, respectively.

As shown in FIG. 1, the display interface circuit 114 may be arranged to couple the display panel 150 to the host processor 110, and the bus interface circuit 116 may be arranged to couple at least one component to the host processor 110 through the bus 105B, where the aforementioned at least one component may comprise the orientation-related sensor 120, the DRAM 130, and the network interface circuit 140, where the video buffer 132 may be implemented within the DRAM 130, and therefore may be regarded as an external buffer of the host processor 110, but the present invention is not limited thereto. According to some embodiments, the video buffer 132 may be integrated into the host processor 110, and more particularly, may be implemented with an internal buffer of the host processor 110. In addition, the bus interface circuit 116 may conform to a specific communications specification, to allow the host processor 110 to communicate with any of the aforementioned at least one component (e.g. the orientation-related sensor 120 and the DRAM 130; and the video buffer 132, for the case that the video buffer 132 is implemented as an external buffer of the host processor 110 as shown in FIG. 1). For example, the orientation-related sensor 120, the DRAM 130, and the network interface circuit 140 may operate under control of the host processor 110, respectively. Additionally, the video buffer 132 may be implemented with one of multiple buffer regions in the RAM such as the DRAM 130. For example, the video buffer 132 may be arranged to buffer frame information.

According to some embodiments, the circuitry in the host processor 110 shown in FIG. 1 may vary when there is a need. For example, the display interface circuit 114 and the bus interface circuit 116 may be coupled to each other through a direct connection. For another example, within the host processor 110, one or more other components (e.g. a frame buffer for temporarily storing image data to be output to the display panel 150) may be inserted between the display interface circuit 114 and the bus interface circuit 116, and the display interface circuit 114 and the bus interface circuit 116 may be coupled to each other through the one or more other components.

According to some embodiments, the orientation-related sensor 120 may comprise one or a combination of a gyroscope, a magnetometer and a camera. For example, the host processor 110 (e.g. the core circuit 112) running the client APP may perform sensor fusion according to one or more sensing results (e.g. the latest sensing result and historical sensing results) of the orientation-related sensor 120 to generate the multiple orientation detection results, but the present invention is not limited thereto. For another example, the host processor 110 (e.g. the core circuit 112) running the client APP may perform image detection with aid of the camera, and more particularly, may obtain face images of the user from the camera and perform face detection of the user according to the face images to generate the multiple orientation detection results.

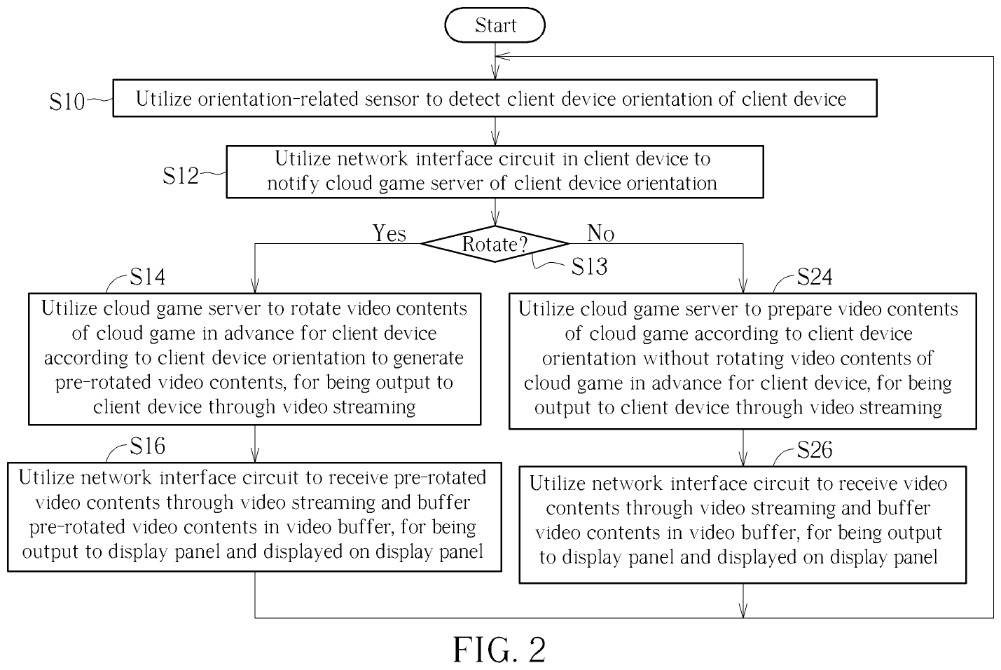

FIG. 2 is a working flow of a method for performing client side latency enhancement with aid of cloud game server side image orientation control according to an embodiment of the present invention. The method may be applied to the electronic device 100 and the cloud game server 10 shown in FIG. 1, and more particularly, may be applied to the host processor 110 (e.g. the core circuit 112 running the program codes 112P) and associated components (e.g. the orientation-related sensor 120, the DRAM 130, and the network interface circuit 140) in architecture of the electronic device 100, as well as the processor 11 running the program codes 11P and associated components (e.g. the GPU 12, the DRAM 13, the network interface circuit 14, and the video encoder 15) in architecture of the cloud game server 10.

In Step S10, the host processor 110 may utilize the orientation-related sensor 120 to detect a client device orientation of the client device such as the electronic device 100. According to this embodiment, the host processor 110 may obtain sensing information from the orientation-related sensor 120, and more particularly, may collect various pieces of sensing information from the orientation-related sensor 120 such as motion, location, position, and environment sensors, and may perform calculation (e.g. sensor fusion) at least according to the sensing information to determine the client device orientation, where the sensing information may comprise one or a combination of motion sensing information, location sensing information, position sensing information and environment sensing information. For example, the user may hold the client device such as the electronic device 100 in one of multiple predetermined client device orientations, such as one of multiple landscape orientations or one of multiple portrait orientations, and the host processor 110 may detect the latest orientation of the electronic device 100.

In Step S12, the host processor 110 may utilize the network interface circuit 140 in the client device such as the electronic device 100 to notify the cloud game server 10 of the client device orientation. According to this embodiment, the host processor 110 may utilize the network interface circuit 140 to transmit an orientation index to the cloud game server 10, to notify the cloud game server 10 of the client device orientation, where the orientation index may indicate the client device orientation.

In Step S13, according to the client device orientation (e.g. the orientation index received from the electronic device 100), the cloud game server 10 (e.g. the processor 11 running the program codes 11P) may determine whether to rotate one or more image frames of the cloud game. If Yes, Step S14 is entered; if No, Step S24 is entered.

In Step S14, the host processor 110 may utilize the cloud game server 10 to rotate video contents (e.g. the one or more image frames) of the cloud game in advance for the client device such as the electronic device 100 according to the client device orientation to generate pre-rotated video contents of the cloud game, such as the pre-rotated video contents corresponding to the client device orientation, for being output to the client device through video streaming. For example, during the video streaming, the cloud game server 10 may encode the pre-rotated video contents by using the video encoder 15, to generate encoded results of the pre-rotated video contents.

In Step S16, the host processor 110 may utilize the network interface circuit 140 to receive the pre-rotated video contents through the video streaming and buffer the pre-rotated video contents in the video buffer 132, without rotating the pre-rotated video contents buffered in the video buffer 132, for being output to the display panel 150 and displayed on the display panel 150. For example, during the video streaming, the client device such as the electronic device 100 may decode the encoded results (e.g., by using the host processor 110 therein) to obtain the pre-rotated video contents.

In Step S24, the host processor 110 may utilize the cloud game server 10 to prepare (e.g. generate) video contents of the cloud game according to the client device orientation without rotating the video contents of the cloud game in advance for the client device such as the electronic device 100, for being output to the client device through the video streaming. For example, during the video streaming, the cloud game server 10 may encode the video contents by using the video encoder 15, to generate encoded results of the video contents.

In Step S26, the host processor 110 may utilize the network interface circuit 140 to receive the video contents through the video streaming and buffer the video contents in the video buffer 132, for being output to the display panel 150 and displayed on the display panel 150. For example, during the video streaming, the client device such as the electronic device 100 may decode the encoded results (e.g., by using the host processor 110 therein) to obtain the video contents.

According to this embodiment, some operations of the working flow shown in FIG. 2 may be repeated, where the latest determination result of Step S13 may lead to execution of the associated operations corresponding to the latest determination result. As time goes by, the user may change the way of holding the electronic device 100, and the host processor 110 may generate the latest orientation detection result (e.g. the latest orientation index) that indicates the latest orientation of the electronic device 100, to make one of the sub-flows of this working flow, such as the sub-flow of Steps S13, S14 and S16 or the sub-flow of Steps S13, S24 and S26, be entered in response to the latest orientation detection result (e.g. the latest orientation index).

For better comprehension, the method may be illustrated with the working flow shown in FIG. 2, but the present invention is not limited thereto. According to some embodiments, one or more steps may be added, deleted, or changed in the working flow shown in FIG. 2.

According to some embodiments, no matter whether the video contents (e.g. the one or more image frames) mentioned in Step S14 are generated first, the cloud game server 10 can generate the pre-rotated video contents of the cloud game in advance for the client device such as the electronic device 100 according to the client device orientation, and the action of rotation may be completed on the server side to generate the pre-rotated video contents corresponding to the client device orientation. This can be achieved by utilizing the GPU 12 of the cloud game server 10 to directly draw the pre-rotated video contents corresponding to the client device orientation, or can be achieved by generating the video contents (e.g. the one or more image frames) of the cloud game first and then rotate these video contents, where the operation of rotating these video contents may be performed by a rotator (ROT) within the cloud game server 10, such as a program module (e.g. a ROT module) running on a certain processor (e.g. the host processor 110 or the GPU 12) of the cloud game server 10 or a dedicated hardware circuit (e.g. a ROT circuit) of the cloud game server 10, but the present invention is not limited thereto. In addition, regarding the working flow shown in FIG. 2, the operation of Step S14 may vary. For example, during utilizing the cloud game server 10 to generate the pre-rotated video contents of the cloud game in advance for the client device such as the electronic device 100 according to the client device orientation, the host processor 110 may utilize the cloud game server 10 (e.g. the GPU 12) to directly generate the pre-rotated video contents corresponding to the client device orientation, having no need to generate the video contents (e.g. the one or more image frames) of the cloud game first and then rotate them.

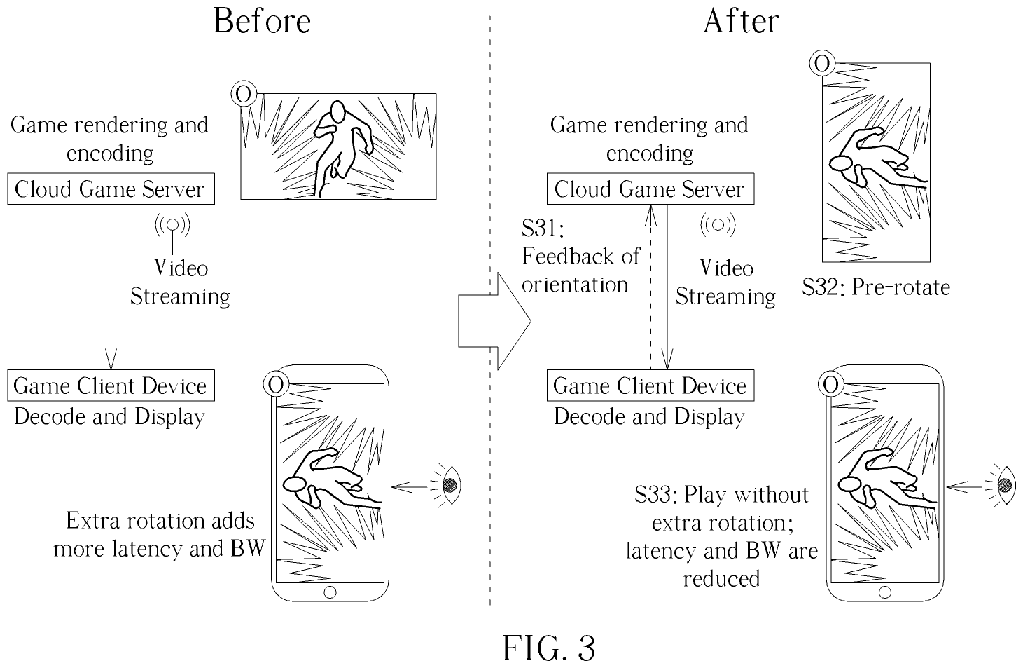

FIG. 3 illustrates a control scheme of the method shown in FIG. 2 according to an embodiment of the present invention, where a case having extra rotation that adds more latency and bandwidth (BW) consumption is also illustrated for better comprehension. As shown in the left half of FIG. 3, the respective origins (labeled “O” for brevity) of the respective coordinate planes of the image frame prepared at the cloud game server side and the image frame displayed at the client side are different from each other, where the symbol of the eye may indicate the direction that somebody is viewing a screen of a game client device. For the game play in a landscape mode, this game client device typically needs to rotate a buffer (more particularly, the buffered video contents of the buffer, such as all image frames buffered in this buffer) to match the display orientation, and therefore may add more latency and bandwidth consumption (labeled “Extra rotation adds more latency and BW” for brevity). For example, when rotating the buffer (more particularly, the buffered video contents of the buffer), the game client device has to perform more operations such as more access (e.g. read and write) operations of the buffer, causing more latency of game control and more bandwidth consumption of one or more internal data paths of the game client device (e.g. one or more input/output (I/O) paths of the buffer). As a result, there may be some problems of the game, such as image lag with respect to audio, delayed image display with respect to user control, etc.

As shown in the right half of FIG. 3, based on the control scheme of this embodiment, the respective origins (labeled “O” for brevity) of the respective coordinate planes of the image frame prepared at the cloud game server side and the image frame displayed at the client side are the same, where the symbol of the eye may indicate the direction that somebody (e.g. the user) is viewing a screen of a game client device operating according to the method (e.g. the client device such as the electronic device 100). For the game play in a landscape mode, this game client device does not need to rotate a buffer such as the video buffer 132 (more particularly, the buffered video contents of the video buffer 132, such as any image frames buffered in the video buffer 132), and therefore can reduce latency and bandwidth consumption (labeled “latency and BW are reduced” for brevity). For example, in Step S31, the game client device may transmit the real-time feedback regarding the game client orientation (e.g. the latest orientation detection result such as the latest orientation index) to the cloud game server 10 (labeled “Feedback of orientation” for brevity). During game rendering and encoding, the cloud game server 10 can utilize the GPU 12 to perform rendering to generate the video contents of the cloud game in a game rendering buffer dedicated to the game rendering of the cloud game (e.g. a buffer region in the DRAM 13), and more particularly, can pre-rotate the video contents (e.g. the video stream contents of the aforementioned at least one video stream) in the game rendering buffer according to the feedback of the game client device in Step S32 (labeled “Pre-rotate” for brevity), for example, by using the processor 11 or the GPU 12, and can further utilize the video encoder 15 to encode the video contents to generate the encoded results of the video contents. Since the video contents should be already matching the orientation of the game client device, the game client device can play back the video contents directly in Step S33, having no need of extra rotation (labeled “Play without extra rotation” for brevity). As a result, the latency and the bandwidth consumption can be reduced.

According to some embodiment, during the game rendering of the cloud game, the cloud game server 10 can utilize the GPU 12 to directly generate the pre-rotated video contents of the cloud game in the game rendering buffer in response to the real-time feedback regarding the game client orientation (e.g. the latest orientation detection result such as the latest orientation index), where the pre-rotated video contents correspond to the latest client device orientation, but the present invention is not limited thereto.

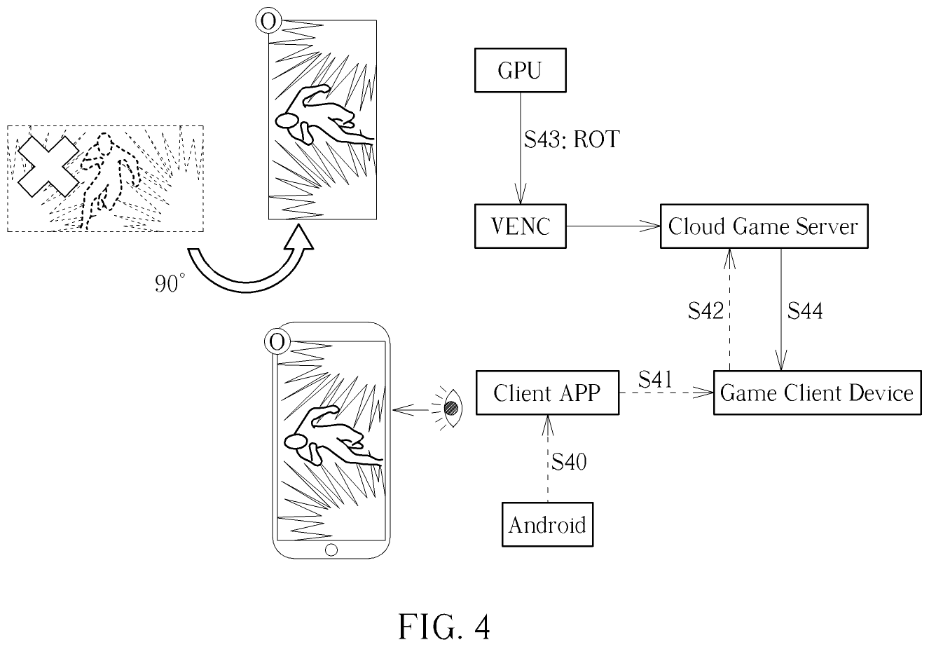

FIG. 4 illustrates some implementation details of the control scheme shown in FIG. 3 according to an embodiment of the present invention, where a 90-degree orientation may be taken as an example of the multiple landscape orientations. Taking Android OS as an example of the OS of the program codes 112P, a lower layer of software modules among multiple layers of software modules within the program codes 112P may provide a function for getting the current screen orientation as below:

//Get current screen orientation
Display display =
((WindowManager)
getSystemService(WINDOW_SERVICE)).getDefaultDisplay( );
int orientation = display.getOrientation( );

but the present invention is not limited thereto. For example, the function may vary for other types of OS.

In Step S40, the client APP may obtain the current screen orientation from the lower layer of software modules (labeled “Android” in FIG. 4 for better comprehension). Under control of the host processor 110 (e.g. the core circuit 112) running the client APP, the game client device (e.g. the client device such as the electronic device 100) may generate an orientation hint indicating the current screen orientation to be the real-time feedback regarding the game client orientation (e.g. the latest orientation detection result such as the latest orientation index) in Step S41, and send the orientation hint to the cloud game server 10 in Step S42. In addition, the cloud game server 10 may generate rotated game contents such as the pre-rotated video contents according to the orientation hint (e.g., by using the GPU 12 to generate the video contents and then rotate them to generate the rotated game contents) to generate the pre-rotated video contents (labeled “ROT” for better comprehension) in Step S43, for being encoded with the video encoder 15 (labeled “VENC” for brevity), and may transmit the aforementioned at least one video stream (e.g. the video stream carrying the rotated game contents in this embodiment) to the game client device in Step S44, for direct playback at the client side.

According to some embodiments, the operation of Step S43 may vary. For example, during generating the pre-rotated video contents according to the orientation hint, the cloud game server 10 may utilize the GPU 12 to directly generate the pre-rotated video contents corresponding to the current screen orientation.

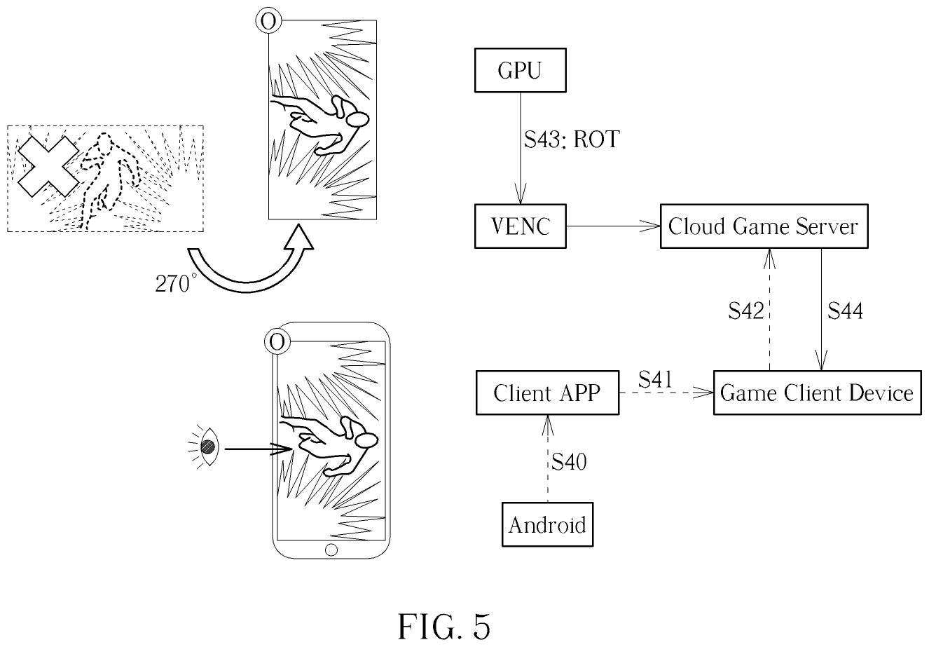

FIG. 5 illustrates some implementation details of the control scheme shown in FIG. 3 according to another embodiment of the present invention, where a 270-degree orientation may be taken as another example of the multiple landscape orientations. The operations of Step S40-S44 may be almost the same as that of the embodiment shown in FIG. 4, except that the 90-degree orientation may be replaced with the 270-degree orientation. For brevity, similar descriptions for this embodiment are not repeated in detail here.

According to some embodiments, at a first time point, the client device orientation mentioned in Step S10 may represent a first client device orientation (e.g. the 90-degree orientation) of the client device, so the operations of Steps S14 and S16 may be performed in response to the latest orientation detection result (e.g. the latest orientation index). At a second time point, the host processor 110 may utilize the orientation-related sensor 120 to detect a second client device orientation (e.g. the 270-degree orientation) of the client device in Step S10, where the client device such as the electronic device 100 may have been rotated from the first client device orientation to the second client device orientation. Then, the host processor 110 may utilize the network interface circuit 140 to notify the cloud game server 10 of the second client device orientation in Step S12. As a result, the sub-flow of Steps S13, S14 and S16 is entered. More particularly, the host processor 110 may utilize the cloud game server 10 to rotate other video contents (e.g. second video contents corresponding to the second time point or a second time period starting from the second time point, rather than first video contents corresponding to the first time point or a first time period between the first time point and the second time point) of the cloud game in advance for the client device such as the electronic device 100 according to the second client device orientation to generate other pre-rotated video contents of the cloud game (e.g. second pre-rotated video contents corresponding to the second time point or the second time period, rather than first pre-rotated video contents corresponding to the first time point or the first time period), for being output to the client device through the video streaming, where the other pre-rotated video contents correspond to the second client device orientation. Additionally, the host processor 110 may utilize the network interface circuit 140 to receive the other pre-rotated video contents through the video streaming and buffer the other pre-rotated video contents in the video buffer 132, for being output to the display panel 150 and displayed on the display panel 150. Taking the embodiments shown in FIG. 4 and FIG. 5 as an example, the first client device orientation and the second client device orientation of these embodiments may belong to the multiple landscape orientations of the client device, and may be detected at different time points (e.g. the first time point and the second time point), respectively.

According to some embodiments, the above operation of utilizing the cloud game server 10 to rotate the other video contents of the cloud game in advance for the client device such as the electronic device 100 according to the second client device orientation to generate the other pre-rotated video contents of the cloud game may vary. For example, during utilizing the cloud game server 10 to generate the other pre-rotated video contents of the cloud game (e.g. the second pre-rotated video contents corresponding to the second time point or the second time period) in advance for the client device such as the electronic device 100 according to the second client device orientation, the host processor 110 may utilize the cloud game server 10 (e.g. the GPU 12) to directly generate the other pre-rotated video contents corresponding to the second client device orientation, having no need to generate the other video contents (e.g. the second video contents corresponding to the second time point or the second time period starting from the second time point) of the cloud game first and then rotate them.

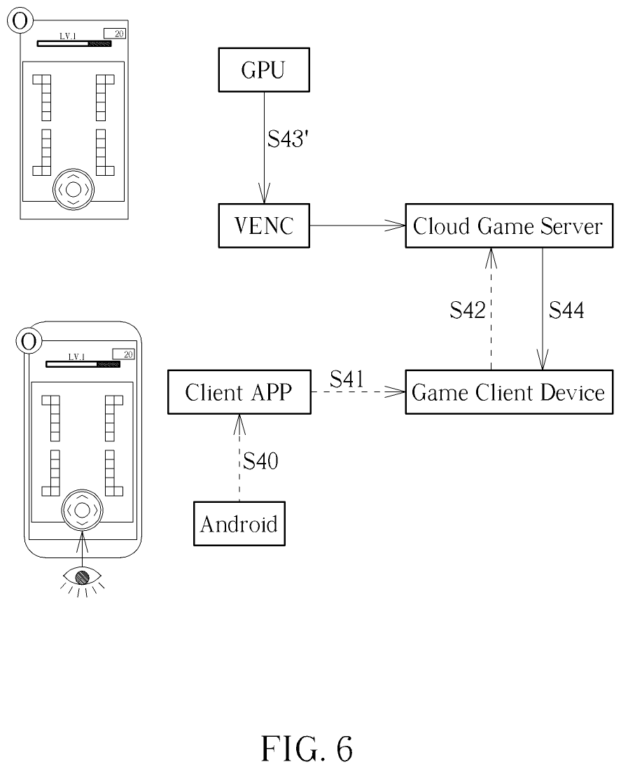

FIG. 6 illustrates some implementation details of the control scheme shown in FIG. 3 according to another embodiment of the present invention, where a 0-degree orientation may be taken as an example of the multiple portrait orientations. The operations of Step S40-S42 and S44 may be almost the same as that of the embodiment shown in FIG. 4, except that the 90-degree orientation may be replaced with the 0-degree orientation and the cloud game may be changed to run in a portrait mode. As the respective origins (labeled “0” for brevity) of the respective coordinate planes of the image frame prepared at the cloud game server side and the image frame displayed at the client side are the same, rotating the image frame prepared at the cloud game server side is not needed, and therefore, Step S43 may be replaced with Step S43′ to correspond to this situation. For example, the cloud game server 10 may utilize the GPU 12 to generate non-rotated game contents such as the video contents mentioned in Step S24 according to the orientation hint in Step S43, for being encoded with the video encoder 15 (labeled “VENC” for brevity), and may transmit the aforementioned at least one video stream (e.g. the video stream carrying the non-rotated game contents in this embodiment) to the game client device in Step S44, for direct playback at the client side. For brevity, similar descriptions for this embodiment are not repeated in detail here.

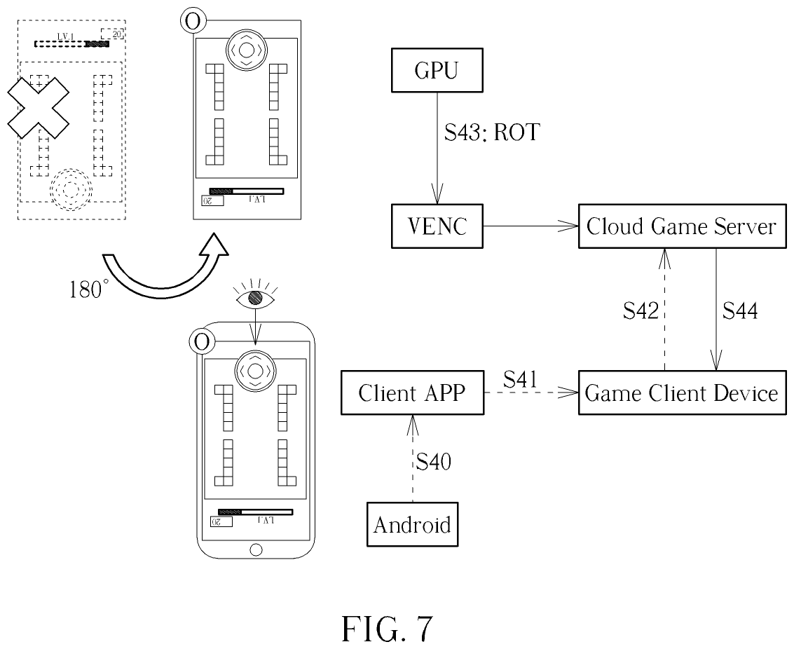

FIG. 7 illustrates some implementation details of the control scheme shown in FIG. 3 according to another embodiment of the present invention, where a 180-degree orientation may be taken as another example of the multiple portrait orientations. The operations of Step S40-S44 may be almost the same as that of the embodiment shown in FIG. 4, except that the 90-degree orientation may be replaced with the 180-degree orientation and the cloud game may be changed to run in the portrait mode. For brevity, similar descriptions for this embodiment are not repeated in detail here.

According to some embodiments, at a first time point, the client device orientation mentioned in Step S10 may represent a first client device orientation (e.g. the 180-degree orientation) of the client device, so the operations of Steps S14 and S16 may be performed in response to the latest orientation detection result (e.g. the latest orientation index). At a second time point, the host processor 110 may utilize the orientation-related sensor 120 to detect a second client device orientation (e.g. the 0-degree orientation) of the client device in Step S10, where the client device such as the electronic device 100 may have been rotated from the first client device orientation to the second client device orientation. Then, the host processor 110 may utilize the network interface circuit 140 to notify the cloud game server 10 of the second client device orientation in Step S12. As a result, the sub-flow of Steps S13, S24 and S26 is entered. More particularly, the host processor 110 may utilize the cloud game server 10 to prepare (e.g. generate) other video contents (e.g. second video contents corresponding to the second time point or a second time period starting from the second time point, rather than first video contents corresponding to the first time point or a first time period between the first time point and the second time point) of the cloud game according to the second client device orientation without rotating the other video contents of the cloud game in advance for the client device such as the electronic device 100, for being output to the client device through the video streaming. Additionally, the host processor 110 may utilize the network interface circuit 140 to receive the other video contents through the video streaming and buffer the other video contents in the video buffer 132, for being output to the display panel 150 and displayed on the display panel 150. Taking the embodiments shown in FIG. 7 and FIG. 6 as an example, the first client device orientation and the second client device orientation of these embodiments may belong to the multiple portrait orientations of the client device, and may be detected at different time points (e.g. the first time point and the second time point), respectively.

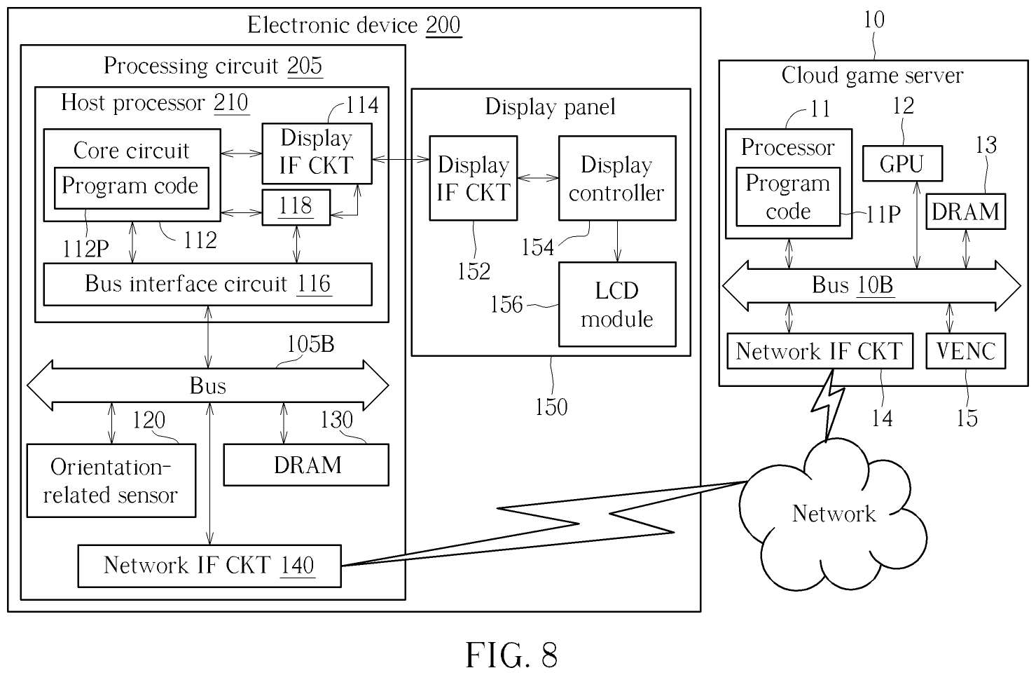

FIG. 8 is a diagram of an electronic device according to another embodiment of the present invention. In comparison with the architecture shown in FIG. 1, an internal memory 118 may be inserted between the display interface circuit 114 and the bus interface circuit 116 to implement the aforementioned frame buffer for temporarily storing the image data to be output to the display panel 150. In response to the change in the architecture, some numerals may be changed correspondingly. For example, the host processor 110, the processing circuit 105, and the electronic device 100 mentioned above may be replaced by the host processor 210, the processing circuit 205, and the electronic device 200, respectively. For brevity, similar descriptions for this embodiment are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing client side latency enhancement with aid of cloud game server side image orientation control, the method comprising:
utilizing at least one orientation-related sensor in a client device to detect a client device orientation of the client device;
utilizing a network interface circuit in the client device to notify a cloud game server of the client device orientation;
utilizing the cloud game server to generate pre-rotated video contents of a cloud game in advance for the client device according to the client device orientation, for being output to the client device through video streaming, wherein the pre-rotated video contents correspond to the client device orientation; and
utilizing the network interface circuit to receive the pre-rotated video contents through the video streaming and buffering the pre-rotated video contents in a video buffer, for being output to a display panel and displayed on the display panel.

2. The method of claim 1, wherein the step of utilizing said at least one orientation-related sensor in the client device to detect the client device orientation of the client device further comprises:
obtaining sensing information from said at least one orientation-related sensor, wherein the sensing information comprises one or a combination of motion sensing information, location sensing information, position sensing information and environment sensing information; and
performing calculation at least according to the sensing information to determine the client device orientation.

3. The method of claim 1, wherein said at least one orientation-related sensor comprises one or a combination of a gyroscope, a magnetometer and a camera.

4. The method of claim 1, wherein the step of utilizing the network interface circuit in the client device to notify the cloud game server of the client device orientation further comprises:
utilizing the network interface circuit to transmit an orientation index to the cloud game server, to notify the cloud game server of the client device orientation, wherein the orientation index indicates the client device orientation.

5. The method of claim 1, wherein during the video streaming, the cloud game server encodes the pre-rotated video contents to generate encoded results of the pre-rotated video contents, and the client device decodes the encoded results to obtain the pre-rotated video contents.

6. The method of claim 1, wherein the step of utilizing the cloud game server to generate the pre-rotated video contents of the cloud game in advance for the client device according to the client device orientation further comprises:
utilizing the cloud game server to rotate video contents of the cloud game in advance for the client device according to the client device orientation to generate the pre-rotated video contents, for being output to the client device through the video streaming.

7. The method of claim 1, wherein the step of utilizing the cloud game server to generate the pre-rotated video contents of the cloud game in advance for the client device according to the client device orientation further comprises:
utilizing the cloud game server to directly generate the pre-rotated video contents corresponding to the client device orientation, for being output to the client device through the video streaming.

8. The method of claim 1, wherein the step of utilizing the network interface circuit to receive the pre-rotated video contents through the video streaming and buffering the pre-rotated video contents in the video buffer further comprises:
utilizing the network interface circuit to receive the pre-rotated video contents through the video streaming and buffering the pre-rotated video contents in the video buffer without rotating the pre-rotated video contents buffered in the video buffer, for being output to the display panel and displayed on the display panel.

9. The method of claim 1, wherein the client device orientation represents a first client device orientation of the client device; and the method further comprises:
utilizing said at least one orientation-related sensor in the client device to detect a second client device orientation of the client device, wherein the client device has been rotated from the first client device orientation to the second client device orientation;
utilizing the network interface circuit in the client device to notify the cloud game server of the second client device orientation;
utilizing the cloud game server to generate other pre-rotated video contents of the cloud game in advance for the client device according to the second client device orientation, for being output to the client device through the video streaming, wherein the other pre-rotated video contents correspond to the second client device orientation; and
utilizing the network interface circuit to receive the other pre-rotated video contents through the video streaming and buffering the other pre-rotated video contents in the video buffer, for being output to the display panel and displayed on the display panel.

10. The method of claim 9, wherein the first client device orientation and the second client device orientation belong to landscape orientations of the client device, and are detected at different time points, respectively.

11. The method of claim 9, wherein the step of utilizing the cloud game server to generate the other pre-rotated video contents of the cloud game in advance for the client device according to the second client device orientation further comprises:
utilizing the cloud game server to rotate other video contents of the cloud game in advance for the client device according to the second client device orientation to generate the other pre-rotated video contents, for being output to the client device through the video streaming.

12. The method of claim 9, wherein the step of utilizing the cloud game server to generate the other pre-rotated video contents of the cloud game in advance for the client device according to the second client device orientation further comprises:
utilizing the cloud game server to directly generate the other pre-rotated video contents corresponding to the second client device orientation, for being output to the client device through the video streaming.

13. The method of claim 1, wherein the client device orientation represents a first client device orientation of the client device; and the method further comprises:
utilizing said at least one orientation-related sensor in the client device to detect a second client device orientation of the client device, wherein the client device has been rotated from the first client device orientation to the second client device orientation;
utilizing the network interface circuit in the client device to notify the cloud game server of the second client device orientation;
utilizing the cloud game server to prepare other video contents of the cloud game according to the second client device orientation without rotating the other video contents of the cloud game in advance for the client device, for being output to the client device through the video streaming; and
utilizing the network interface circuit to receive the other video contents through the video streaming and buffering the other video contents in the video buffer, for being output to the display panel and displayed on the display panel.

14. The method of claim 13, wherein the first client device orientation and the second client device orientation belong to portrait orientations of the client device, and are detected at different time points, respectively.

15. A host processor within an electronic device, applicable to performing client side latency enhancement with aid of cloud game server side image orientation control, the host processor comprising:
a core circuit, arranged to control the host processor, for controlling operations of the electronic device, wherein the electronic device is used as a client device, and under control of the core circuit, the host processor performs interaction control of the client device to perform client side latency enhancement with aid of cloud game server side image orientation control;
a display interface circuit, coupled to the core circuit, arranged to couple a display panel to the host processor; and
a bus interface circuit, coupled to the core circuit, arranged to couple at least one component to the host processor through a bus, wherein said at least one component comprises at least one orientation-related sensor in the client device;
wherein:
the host processor utilizes said at least one orientation-related sensor to detect a client device orientation of the client device;
the host processor utilizes a network interface circuit in the client device to notify a cloud game server of the client device orientation;
the host processor utilizes the cloud game server to generate pre-rotated video contents of a cloud game in advance for the client device according to the client device orientation, for being output to the client device through video streaming, wherein the pre-rotated video contents correspond to the client device orientation; and
the host processor utilizes the network interface circuit to receive the pre-rotated video contents through the video streaming and buffers the pre-rotated video contents in a video buffer, for being output to the display panel and displayed on the display panel.

16. The host processor of claim 15, wherein the host processor obtains sensing information from said at least one orientation-related sensor, wherein the sensing information comprises one or a combination of motion sensing information, location sensing information, position sensing information and environment sensing information; and the host processor performs calculation at least according to the sensing information to determine the client device orientation.

17. The host processor of claim 15, wherein said at least one orientation-related sensor comprises one or a combination of a gyroscope, a magnetometer and a camera.

18. The host processor of claim 15, wherein the host processor utilizes the network interface circuit to transmit an orientation index to the cloud game server, to notify the cloud game server of the client device orientation, wherein the orientation index indicates the client device orientation.

19. The host processor of claim 15, wherein during the video streaming, the cloud game server encodes the pre-rotated video contents to generate encoded results of the pre-rotated video contents, and the client device decodes the encoded results to obtain the pre-rotated video contents.

20. The host processor of claim 15, wherein the host processor utilizes the cloud game server to rotate video contents of the cloud game in advance for the client device according to the client device orientation to generate the pre-rotated video contents, for being output to the client device through the video streaming.

21. The host processor of claim 15, wherein the host processor utilizes the cloud game server to directly generate the pre-rotated video contents corresponding to the client device orientation, for being output to the client device through the video streaming.

22. The host processor of claim 15, wherein the host processor utilizes the network interface circuit to receive the pre-rotated video contents through the video streaming and buffers the pre-rotated video contents in the video buffer without rotating the pre-rotated video contents buffered in the video buffer, for being output to the display panel and displayed on the display panel.

23. The host processor of claim 15, wherein the client device orientation represents a first client device orientation of the client device, wherein:
the host processor utilizes said at least one orientation-related sensor in the client device to detect a second client device orientation of the client device, wherein the client device has been rotated from the first client device orientation to the second client device orientation;
the host processor utilizes the network interface circuit in the client device to notify the cloud game server of the second client device orientation;
the host processor utilizes the cloud game server to generate other pre-rotated video contents of the cloud game in advance for the client device according to the second client device orientation, for being output to the client device through the video streaming, wherein the other pre-rotated video contents correspond to the second client device orientation; and
the host processor utilizes the network interface circuit to receive the other pre-rotated video contents through the video streaming and buffering the other pre-rotated video contents in the video buffer, for being output to the display panel and displayed on the display panel.

24. The host processor of claim 23, wherein the first client device orientation and the second client device orientation belong to landscape orientations of the client device, and are detected at different time points, respectively.

25. The host processor of claim 23, wherein the host processor utilizes the cloud game server to rotate other video contents of the cloud game in advance for the client device according to the second client device orientation to generate the other pre-rotated video contents, for being output to the client device through the video streaming.

26. The host processor of claim 23, wherein the host processor utilizes the cloud game server to directly generate the other pre-rotated video contents corresponding to the second client device orientation, for being output to the client device through the video streaming.

27. The host processor of claim 15, wherein the client device orientation represents a first client device orientation of the client device, wherein:
the host processor utilizes said at least one orientation-related sensor in the client device to detect a second client device orientation of the client device, wherein the client device has been rotated from the first client device orientation to the second client device orientation;
the host processor utilizes the network interface circuit in the client device to notify the cloud game server of the second client device orientation;
the host processor utilizes the cloud game server to prepare other video contents of the cloud game according to the second client device orientation without rotating the other video contents of the cloud game in advance for the client device, for being output to the client device through the video streaming; and
the host processor utilizes the network interface circuit to receive the other video contents through the video streaming and buffering the other video contents in the video buffer, for being output to the display panel and displayed on the display panel.

28. The host processor of claim 27, wherein the first client device orientation and the second client device orientation belong to portrait orientations of the client device, and are detected at different time points, respectively.

29. A processing circuit comprising the host processor of claim 15, further comprising:
said at least one orientation-related sensor; and
the network interface circuit.

30. The processing circuit of claim 29, wherein the processing circuit comprises:
the video buffer, arranged to buffer frame information, wherein the frame information comprises the pre-rotated video contents;
wherein the video buffer is implemented to be an internal buffer or an external buffer of the host processor.

31. The electronic device comprising the host processor of claim 15, wherein the electronic device comprises:
a processing circuit, comprising:
the host processor;
said at least one orientation-related sensor; and
the network interface circuit; and
the display panel, coupled to the host processor, arranged to display information.

32. The electronic device of claim 31, wherein the processing circuit comprises:
the video buffer, arranged to buffer frame information, wherein the frame information comprises the pre-rotated video contents;
wherein the video buffer is implemented to be an internal buffer or an external buffer of the host processor.

33. A cloud game server, applicable to performing client side latency enhancement with aid of cloud game server side image orientation control, the cloud game server comprising:
at least one processor, arranged to control operations of the cloud game server, wherein under control of said at least one processor, the cloud game server performs game control and selectively performs image rotation for a client device to perform client side latency enhancement with aid of cloud game server side image orientation control; and
a network interface circuit, arranged to couple the cloud game server to the client device through at least one network;
wherein:
at least one orientation-related sensor in the client device is configured to detect a client device orientation of the client device;
the client device is configured to notify a cloud game server of the client device orientation;
the cloud game server is configured to generate pre-rotated video contents of a cloud game in advance for the client device according to the client device orientation, for being output to the client device through video streaming, wherein the pre-rotated video contents correspond to the client device orientation; and
the client device is configured to receive the pre-rotated video contents through the video streaming and buffer the pre-rotated video contents in a video buffer, for being output to a display panel and displayed on the display panel.

34. The cloud game server of claim 33, wherein the cloud game server is configured to rotate video contents of the cloud game in advance for the client device according to the client device orientation to generate the pre-rotated video contents, for being output to the client device through the video streaming.

35. The cloud game server of claim 33, wherein the cloud game server is configured to directly generate the pre-rotated video contents corresponding to the client device orientation, for being output to the client device through the video streaming.
